(19) United States
(12) Patent Application Publication
(10) Pub. No.: US 2013/0126072 A1
(43) Pub. Date: May 23, 2013

(54) FABRICATION OF CATALYST COATED ELECTRODE SUBSTRATE WITH LOW LOADINGS USING DIRECT SPRAY METHOD

(71) Applicants: TAEHEE HAN, FARMINGTON HILLS, MI (US); NILESH DALE, FARMINGTON HILLS, MI (US); KEVORK ADJEMIAN, BIRMINGHAM, MI (US)

(72) Inventors: TAEHEE HAN, FARMINGTON HILLS, MI (US); NILESH DALE, FARMINGTON HILLS, MI (US); KEVORK ADJEMIAN, BIRMINGHAM, MI (US)

(73) Assignee: NISSAN NORTH AMERICA, INC., Franklin, TN (US)

(21) Appl. No.: 13/301,201

(22) Filed: Nov. 21, 2011

(51) Int. Cl. B32B 38/14; B05D 5/12

(52) U.S. Cl. 156/182; 427/115

(57) ABSTRACT

Disclosed herein are methods of making a membrane electrode assembly for a fuel cell. One method disclosed herein comprises preparing a catalyst ink of a predetermined viscosity, masking an electrode substrate having a first surface and a second surface on the first surface with a magnetic mask, spraying the catalyst ink on the first surface of the electrode substrate, and drying the catalyst ink by heating the electrode substrate and the magnetic mask in an oven at a predetermined temperature for a predetermined period of time.

### TECHNICAL FIELD

The present invention relates in general to the manufacture of fuel cell gas diffusion electrode fabrication, and in particular to a catalyst coated electrode substrate such as a membrane or gas diffusion layer.

### BACKGROUND

Membrane electrode assemblies are used in fuel cells, where oxygen and hydrogen react at the gas diffusion electrodes, to form water, while converting the chemical bond energy into electrical energy. Membrane electrode assemblies can include gas diffusion electrodes that are typically fabricated by applying catalyst ink to gas diffusion layers. Because the application of the catalyst ink is important to the performance of the fuel cell, optimizing catalyst ink characteristics that improve application is of interest in the field.

### SUMMARY

Disclosed herein are methods of making a membrane electrode assembly for a fuel cell. One method disclosed herein comprises preparing a catalyst ink of a predetermined viscosity, masking an electrode substrate having a first surface and a second surface on the first surface with a magnetic mask, spraying the catalyst ink on the first surface of the electrode substrate and drying the catalyst ink by heating the electrode substrate and the magnetic mask in an oven at a predetermined temperature for a predetermined period of time.

Another method disclosed herein comprises preparing a catalyst ink of a predetermined viscosity, masking a membrane having a first surface and a second surface on both of the first surface and second surface with a magnetic mask, spraying the catalyst ink on the first surface of the membrane, drying the catalyst ink by heating the membrane and the magnetic mask in an oven at a predetermined temperature for a predetermined period of time, spraying the catalyst ink on the second surface of the membrane and drying the catalyst ink by heating the membrane and the magnetic mask in the oven at the predetermined temperature for the predetermined period of time.

Another method of making a membrane electrode assembly for a fuel cell comprises preparing a catalyst ink of a predetermined viscosity and masking a membrane having a first surface and a second surface with a magnetic mask. The magnetic mask comprises a first portion positioned on the first surface, producing a first treatment area, and a second portion positioned on the second surface directly aligned with the first portion, producing a second treatment area. An active electrode layer is formed by spraying the catalyst ink on the first treatment area and drying the catalyst ink by heating the membrane and the magnetic mask in an oven at a predetermined temperature for a predetermined period of time.

Another method of making a membrane electrode assembly for a fuel cell disclosed herein comprises preparing a catalyst ink of a predetermined viscosity, masking a first gas diffusion layer on a first surface of the first gas diffusion layer with a magnetic mask, spraying the catalyst ink on the first surface of the first gas diffusion layer, drying the catalyst ink by heating the first gas diffusion layer and the magnetic mask in an oven at a predetermined temperature for a predetermined period of time, masking a second gas diffusion layer on a first surface of the second gas diffusion layer with the magnetic mask, spraying the catalyst ink on the first surface of the second gas diffusion layer and drying the catalyst ink by heating the second gas diffusion layer and the magnetic mask in the oven at the predetermined temperature for the predetermined period of time.

### BRIEF DESCRIPTION OF THE DRAWINGS

The various features, advantages and other uses of the present apparatus will become more apparent by referring to the following detailed description and drawing in which:

FIG. 1 is a schematic cross-sectional illustration of a basic fuel cell stack having multiple membrane electrode assemblies;

FIG. 2 is an enlarged schematic cross-sectional view of a membrane electrode assembly from the fuel cell stack of FIG. 1;

FIG. 3 is a flow diagram of one of the methods disclosed herein;

FIG. 4A is a plan view of a membrane as disclosed herein;

FIG. 4B is a plan view of a magnetic mask as disclosed herein;

FIG. 4C is a plan view of the magnetic mask of FIG. 4B masking the membrane of FIG. 4A;

FIG. 5 is a cross sectional view of the masked membrane of FIG. 4C along line 5-5;

FIG. 6A is an expanded plan view of the membrane and magnetic mask;

FIG. 6B is a schematic of FIG. 6A being sprayed with catalyst ink;

FIG. 6C is a plan view of a catalyst layer on the membrane;

FIG. 7 is a schematic of the catalyst coated membrane being assembled with two gas diffusion layers;

FIG. 8A is a graph comparing the cell potential of two different catalyst loadings;

FIG. 8B is a graph comparing the electrochemical area of the two different catalyst loadings;

FIG. 8C is a graph comparing the double layer capacitance of the two different catalyst loadings;

FIG. 9A is a graph comparing the current density of the two different catalyst loadings;

FIG. 9B is a graph comparing the Tafel slope for the two different catalyst loadings;

FIG. 10A is an expanded plan view of another embodiment using a gas diffusion layer with the magnetic mask;

FIG. 10B is a schematic of FIG. 10A being sprayed with catalyst ink;

FIG. 10C is a plan view of a gas diffusion electrode;

FIG. 11 is a flow diagram of another of the methods disclosed herein; and

FIG. 12 is a schematic of two gas diffusion electrodes being assembled with a membrane.

### DETAILED DESCRIPTION

A proton exchange membrane fuel cell is an electrochemical device converting chemical energy to an electrical energy by using hydrogen as a fuel and oxygen/air as an oxidant. The proton exchange membrane fuel cell generally comprises five layers to form a fuel cell membrane electrode assembly, including a solid polymer electrolyte proton conducting membrane, two of gas diffusion layers, and two electrocatalyst layers.

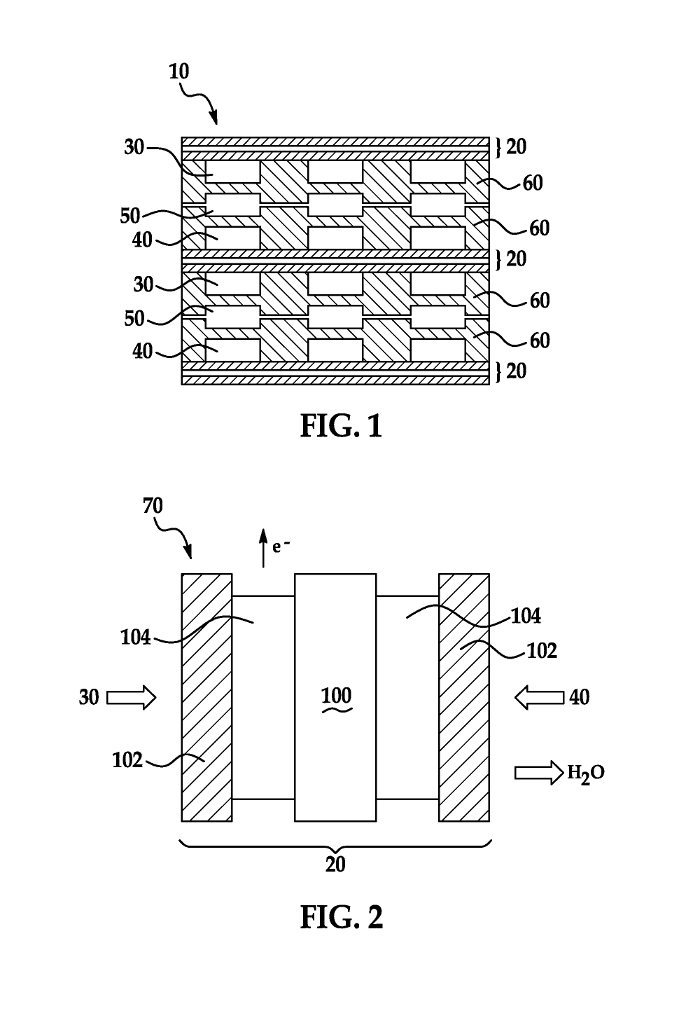

FIG. 1 shows a schematic cross-sectional illustration of a portion of a fuel cell stack 10. The illustration is provided as an example of the use of electrode substrates and is not meant to be limiting. The fuel cell stack 10 is comprised of multiple membrane electrode assemblies 20. Fuel 30 such as hydrogen is fed to the anode side of a membrane electrode assembly 20, while an oxidant 40 such as oxygen or air is fed to the cathode side of the membrane electrode assembly 20. Coolant 50 is supplied between the fuel 30 and oxidant 40, the coolant 50 separated from the fuel 30 and oxidant 40 by separators 60.

FIG. 2 is an illustration of one of the plurality of fuel cells 70 in the fuel cell stack 10. The fuel cell 70 is comprised of a single membrane electrode assembly 20. The membrane electrode assembly 20 has a catalyst coated membrane 100 with a gas diffusion layer 102 on opposing sides of the membrane 100. The membrane 100 has a catalyst layer 104 formed on opposing surfaces of the membrane 100, such that when assembled, the catalyst layers are each between the membrane 100 and a gas diffusion layer 102. Alternatively, a gas diffusion electrode is made by forming one catalyst layer 104 on a surface of two gas diffusion layers 102 and sandwiching the membrane 100 between the gas diffusion layers 102 such that the catalyst layers 104 contact the membrane 100.

When fuel 30, such as hydrogen gas, is introduced into the fuel cell 70, the catalyst layer 104 of the catalyst coated membrane 100 splits hydrogen gas molecules into protons and electrons. The protons pass through the membrane 100 to react with the oxidant 40, such as air, forming water (H₂O). The electrons (e⁻), which cannot pass through the membrane 100, must travel around it, thus creating the source of electrical energy.

The gas diffusion layer 102 is typically a layer of light, mechanically stable support material such as macroporous carbon paper or cloth. The carbon paper can be coated with carbon black. The carbon black can be mixed with an organic binder. The carbon material provides a gas diffusion layer 102 that is light weight with high open porosity. Other material can alternatively be used, such as materials in the form of nonwovens or other papers or woven cloth comprising glass fibers or fibers comprising organic polymers. The gas diffusion layer 102 serves as a current collector that allows ready access of fuel 30 and oxidant 40 to the anode and the cathode catalyst surfaces, respectively.

The methods disclosed herein particularly relate to the fabrication of a low loading catalyst coated electrode substrate to reduce material cost by reducing the amount of precious metal in the catalyst and simplifying the fuel cell manufacturing process by eliminating hot-pressing while maintaining fuel cell iV performance without appreciable potential loss.

As used herein, the term “electrode substrate” indicates one of a layer of the membrane electrode assembly 120 on which the catalyst layers 104 can be formed and thus includes the membrane 100 and the gas diffusion layers 102. The examples provided herein refer to the membrane 100 or the gas diffusion layer 102 to provide clarity to the embodiments discloses herein but should not be construed to limit the respective embodiment to the membrane 100 or the gas diffusion layers 102.

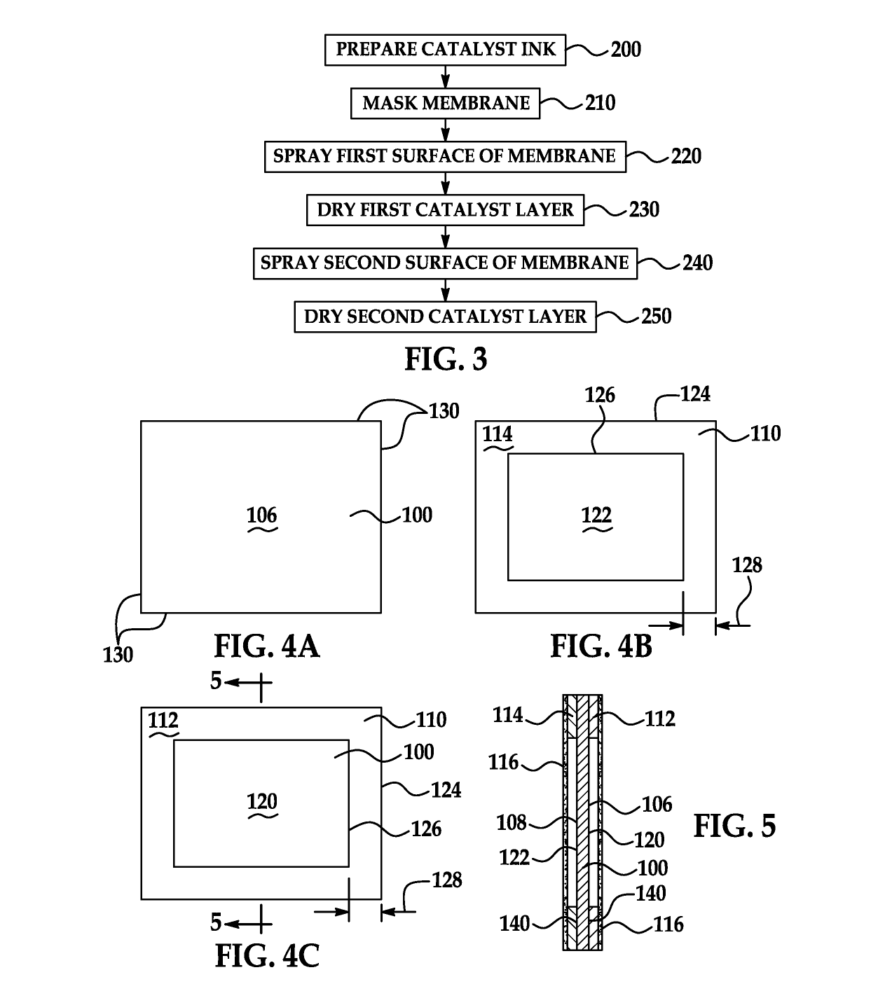

FIG. 3 is a flow diagram of a method of fabricating a membrane electrode assembly 20 for use in a fuel cell 70. The first step 200 is to prepare a catalyst ink of a predetermined viscosity. In the next step 210, an electrode substrate, here, a membrane 100 (shown in FIG. 5) having a first surface 106 and a second surface 108 is masked on both of the first surface 106 and second surface 108 with a magnetic mask 110. In step 220, the catalyst ink is sprayed on the first surface 106 of the membrane 100, forming a catalyst layer 104. The catalyst layer 104 is dried by heating the membrane 100 and the magnetic mask 110 in an oven at a predetermined temperature for a predetermined period of time in step 230. The catalyst ink is then sprayed on the second surface 108 of the membrane 100 to form another catalyst layer 104′ in step 240, and the catalyst layer 104′ is dried by heating the membrane 100 and the magnetic mask 110 in the oven at the predetermined temperature for the predetermined period of time in step 250.

The first step 200 of preparing a catalyst ink that forms the catalyst layers 104, 104′ of the catalyst coated membrane 100 is important to ensure that the catalyst layers 104, 104′ result in fuel cell electrodes with the required loading for optimized fuel cell performance. Catalyst ink homogeneity and viscosity are important control parameters for electrode manufacturing efficiency and also for fuel cell performance. One way to control the amount of catalyst loading is by adjusting either fluid pressure or the spray nozzle opening of the spray system. Since the conventional fuel cell catalyst mainly uses precious group metals (PGM), reduction in the amount of loading is desired for any fuel cell application's cost reduction (both vehicular and stationary). The preparation of catalyst ink 200 for use in the methods disclosed herein can be found in U.S. patent application Ser. No. 13/026,646 filed on Feb. 14, 2011 and incorporated by reference herein in its entirety.

The catalyst solution comprises catalyst particles, an ionomer and a solvent. The catalyst particles used in the catalyst solution are an electrically conductive material, typically in powder form, which can comprise, for example, carbon as a support structure supporting a metal which is insoluble or only very slightly soluble in water with low oxidation sensitivity. Non-limiting examples of such a metal include titanium, gold, platinum, palladium, silver and nickel and mixtures thereof. One non-limiting example of a catalyst powder used herein comprises platinum particles supported on carbon. The carbon support of the catalyst is electrically conductive and porous, so that sufficient conductivity and gas-permeability of the catalytic layer is ensured. Carbon minimizes electronic resistance of the electrode while platinum serves as the catalyst for the electrochemical reaction.

The ionomer included in the catalyst solution is a proton-conducting polymer that can simultaneously serve as a binder for the catalyst layers 104, 104′. The ionomer can be a high molecular weight material capable of conducting hydrogen ions, such as perfluorosulfonic acid and non-fluorinated acidified hydrocarbon ionomers. The ionomer enables protons to be conducted between catalytic sites.

The solvent improves the ability to prepare the solution as it improves the wettability of the electrically conductive catalyst particles, thus making them more miscible. Typical solvents are, as non-limiting examples, deionized water and alcohols, such as isopropanol and ethanol. More than one type of solvent can be used.

When the proper catalyst solution is prepared, the membrane 100 is prepared for spraying. The membrane 100 can include, as a non-limiting example, polytetrafluoroethylene (PTFE) or ePTFE, hydrocarbon membranes, perfluorosulfonic acid (PSFA) or other sulfonic acid with various equivalent weights (EW) etc.

The membrane 100 is prepared for spraying in step 210 by masking the membrane 100 with the magnetic mask 110. FIGS. 4A-C, 5 and 6 illustrate an example of the membrane 100 and magnetic mask 110. The magnetic mask 110 has a first portion 112 and a second portion 114, with the first and second portions 112, 114 attracted to each other. The first and second portions 112, 114 are illustrated as being identical in shape and size, as seen in the plan view of FIG. 4B. Mirrored first and second portions are illustrated as a non-limiting example. The first and second portions 112, 114 can be different in shape or size depending on the requirements of the catalyst layer 104, 104′. The magnetic mask 110 can be a magnetic metal. Preferably, the magnetic mask 110 is a flexible magnetic polymer. The first and second portions 112, 114 of the magnetic mask 110 can be two magnets with opposite poles facing each other to attract, or one of them being magnetic, and the other being made of metal that is attracted to the magnet. The first and second portion 112, 114 of the magnetic mask can also be any combination of polymer and metal. The magnetic mask 110 can be covered in a non-reactive coating 116 such as Teflon®. The coating 116 can prevent contamination of the membrane with metal, can prevent degradation of the metal mask, and can ease cleaning of the mask for repetitive use of the magnetic mask 110.

The first portion 112 of the magnetic mask 110 masks the first surface 106 of the membrane 100, leaving exposed a first treatment surface 120, as shown in FIG. 4C. The second portion 114 of the magnetic mask 110 masks the second surface 108 of the membrane 110, leaving exposed a second treatment surface 122. The first and second portions 112, 114 of the magnetic mask 110 produce a frame around each of the first and second surfaces 106, 108 of the membrane 100. Each of the first and second portions 112, 114 of the magnetic mask 110 has an exterior perimeter 124 and an interior perimeter 126 spaced from the exterior perimeter 124 by a width 128, as seen in FIGS. 4B and 4C. The membrane 100 has a perimeter 130, shown in FIG. 4A. The magnetic mask 110 can be configured so that the exterior perimeter 124 of the magnetic mask 110 aligns with the perimeter 130 of the membrane 100 when the magnetic mask 110 is placed on the membrane 100 in step 210.

When both the first and second surfaces 106, 108 are masked with the magnetic mask 110, the catalyst ink can be sprayed on the first treatment surface 120 of the membrane 110 in step 220. Direct spraying on to the membrane 100 can be challenging due to the thinness of the membrane. Fuel cell membranes are generally very thin polymer, so it can also be challenging to keep the membrane 100 in a fixed position for spraying. Traditionally, paper or adhesive masks are used. However, these light weight masks do not improve the ease of handling the membrane 100 and maintaining the membrane 100 in the fixed position. Furthermore, the paper or adhesive masks may not prevent wrinkling of the membrane in the treatment area, which causes an uneven catalyst layer and can result in a greater use of precious metals than necessary to achieve performance. In an attempt to eliminate some of these issues of the paper or adhesive masks, a vacuum function of a spray system is utilized to hold the membrane in the fixed position to control the spray area. However, the use of the vacuum is expensive and inefficient due to additional gas usage and the likelihood of damaging the thin membrane if the vacuum pulls too much pressure.

The use of the magnetic mask 110 eliminates these issues and does not require the use of the vacuum. The weight of the magnetic mask 110, the rigidity of the magnetic mask 110 and the magnetic grip of the magnetic mask 110 onto the membrane 100 all work together to keep the membrane 100 in the fixed position and taut so that no wrinkles form in the treatment surfaces 120, 122.

In step 220, catalyst ink is sprayed onto the treatment surface 120 of the first surface 106 of the membrane 100. Because the membrane 100 is hydrophobic, the ink recipe is important in obtaining the desired uniformity and loading. Using the catalyst ink recipe disclosed in U.S. patent application Ser. No. 13/026,646, along with the magnetic mask disclosed herein, a single spray application can achieve the desired or required catalyst loading uniformly across the treatment surface 120. To achieve the appropriate loading and uniformity of the homogenized catalyst ink, viscosity of the catalyst ink is such that the ink is sprayable with the pressure, speed and nozzle size of the spray device. For example, a uniform catalyst layer with catalyst loadings as low as 0.05 to 0.2 mg_{Pt/}cm² can be achieved. Optimized parameters such as fluid pressure of about 2 to 3 psi, air pressure of 4 psi and 24 gauge spray nozzle with opening of 0.15 to 0.3 mm are used based on catalyst ink recipe to get the required catalyst loadings with the catalyst recipe. The membrane 100 being a different color as the catalyst ink also assists in obtaining the quality of the catalyst layers 104, 104′.

The ability to achieve a uniform layer of catalyst resulting in a uniform loading of the desired or required amount of active catalyst material in a single spray has many advantages, including reduction in time, reduction in amount of overspray, reduction in catalyst costs, and others. Due to the high cost of platinum, any reduction in platinum in the fabrication of the electrodes is advantageous. Furthermore, the viscosity of the catalyst ink results in better dispersion without running across the surface of the membrane 100. This eliminates the need for using hot plates and/or a system platform with heating capability to accelerate the drying the catalyst ink while it is being sprayed to avoid running.

In step 230, the sprayed membrane 100 and magnetic mask 110 are placed in an oven to dry the catalyst ink. The membrane 100 is dried along with the magnet mask 110 in the oven to produce the catalyst layer 104. The temperature and length of time required for drying depend on the type of solvents used in the catalyst ink, as well as the type of membrane 100 and ionomer used. In general, drying occurs at temperatures above room temperature and for a predetermined period of time. For example, drying can occur in an oven in either air or inert gas at temperatures ranging from about 75° C. to about 85° C. The predetermined period of time can be between twenty and thirty minutes, as a non-limiting example.

The dried membrane 100 with the catalyst layer 104 and the magnetic mask 110 are then removed from the oven. The membrane 100 and magnetic mask 110 are turned over and treatment surface 220 is then sprayed with catalyst ink in step 240. Step 240 repeats step 220 and will not be described in detail. The sprayed membrane 100 and magnetic mask 110 are again placed in the oven to dry the catalyst ink. In step 250, the membrane 100 is dried along with the magnet mask 110 in the oven at about 75 to 85° C. for about 20 to 30 minutes as before in step 230. The dried membrane 100 with the catalyst layers 104, 104′ and the magnetic mask are then removed from the oven.

With the catalyst layers 104, 104′ formed, the magnetic mask 110 can be removed from the membrane 100. Because no adhesive is required for the magnetic mask 110, removal can be done quickly with no residue remaining on the membrane and no damage occurring to the edges of the membrane 100. Because the edge of the membrane 100 is typically a weak point of the membrane 100, it is difficult to prevent damage to the edges when unmasking, such as pinholes, thinning and other damage that results in electric shorts during operation. Use of the magnetic mask 110 eliminates this problem. The use of the magnetic mask 110 reduces the handling requirements of the membrane 100 after the catalyst layers 104, 104′ have been applied, preventing damage to the catalyst layers 104, 104′ or loss of catalyst from the catalyst layers 104, 104′, as the dried catalyst ink is brittle.

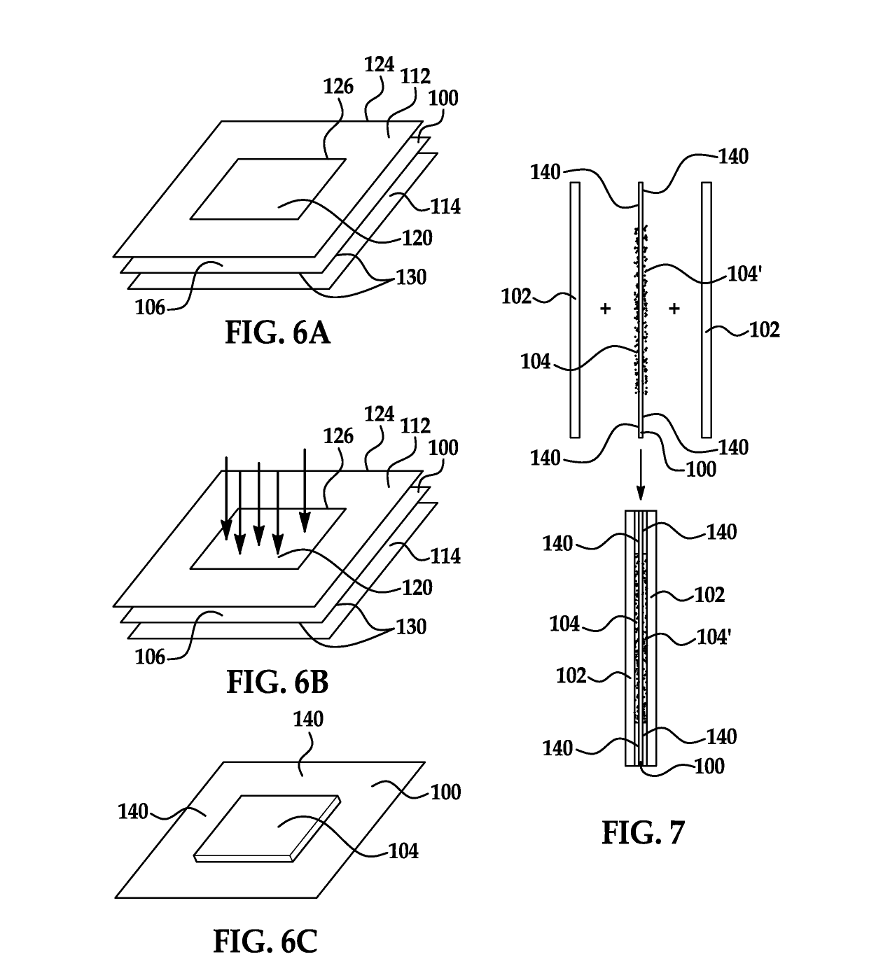

FIG. 6C illustrates the membrane 100 with the catalyst layer 104 after the magnetic mask 110 has been removed. As shown in FIG. 6C, the catalyst layer 104 is surrounded by a border 140 of clear membrane. The width of this border 140 corresponds to the width 128 of the magnetic mask 110. The width 128 of the magnetic mask 110, and thus the width of the border 140, can be configured to produce the required dead space around the catalyst layers 104, 104′ where the membrane electrode assemblies 120 are assembled along with other layers to produce the fuel cell stack 10. By corresponding the width 128 of the magnetic mask 110 to the width of the required dead space, catalyst use is optimized.

After drying the catalyst layers 104 and 104′ and removing the magnetic mask 110, the membrane electrode assembly 20 is then simply assembled by sandwiching the catalyst coated membrane 100 having the catalyst layers 104, 104′ with two gas diffusion layers, as shown in FIG. 7. This fabrication method does not involve any hot-pressing step, acid/water treatment step, or pre-spraying ionomer step, making the manufacturing process simpler and more economical. The hot-pressing step in the manufacture of fuel cell membrane electrode assemblies can result in damage to a membrane such as pinholes, membrane thinning or shorts between electrodes, as non-limiting examples.

The proposed method can be applied either to the anode and/or cathode side catalyst electrode fabrication with different target loadings and different catalyst ink recipes, including non-precious metal group catalysts.

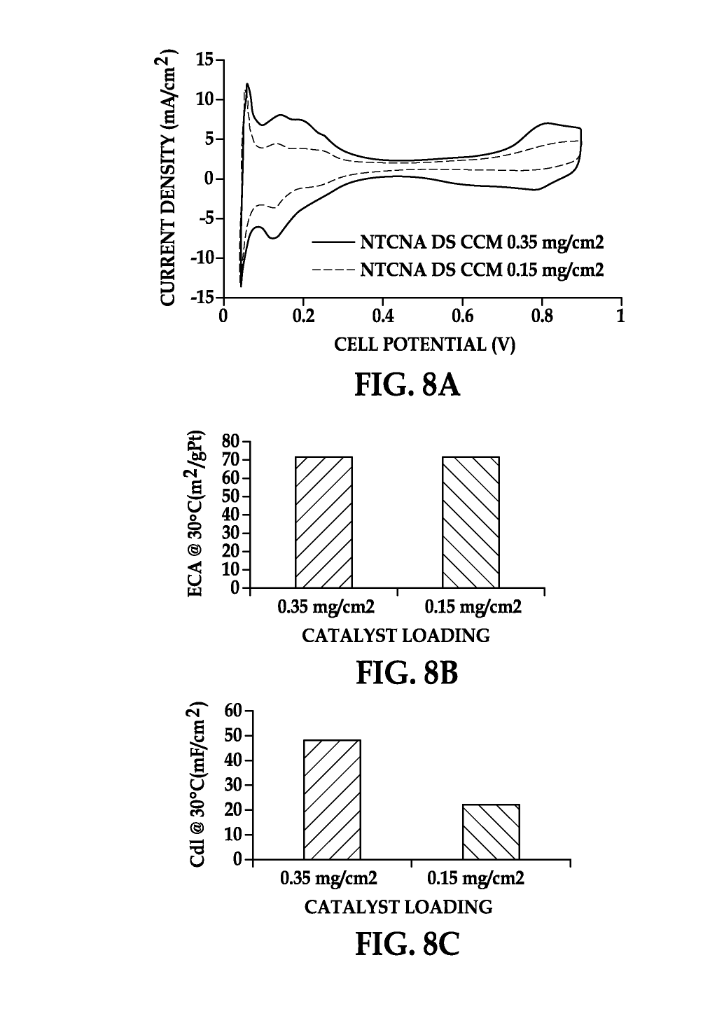

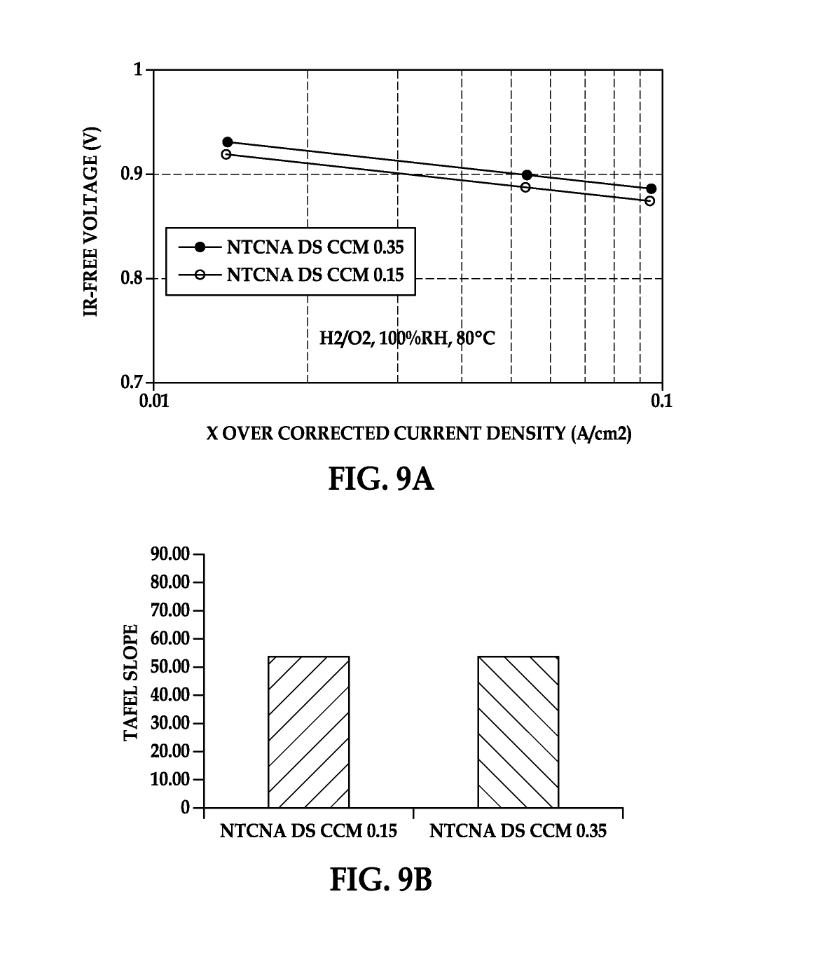

FIGS. 8 and 9 show a comparison of 0.35 mg/cm² loading and 0.15 mg/cm² loading on a cathode in cyclic voltammetry (CV) and IV performance. As shown in FIG. 8B, the electrochemical area (ECA) is similar since the ECA calculation is normalized by loading. Double layer capacitance (Cdl) is much lower for 0.15 mg/cm² loading due to the relatively lower amount of carbon in the low loading membrane electrode assembly, as shown in FIG. 8C. However, iV performances with air and oxygen under different relative humidity (FIGS. 9A and 9B) show similar performance without considerable potential loss. This can be partly due to better gas transport and water management and better catalyst utilization since the thickness of the catalyst layers with the low loading is reduced.

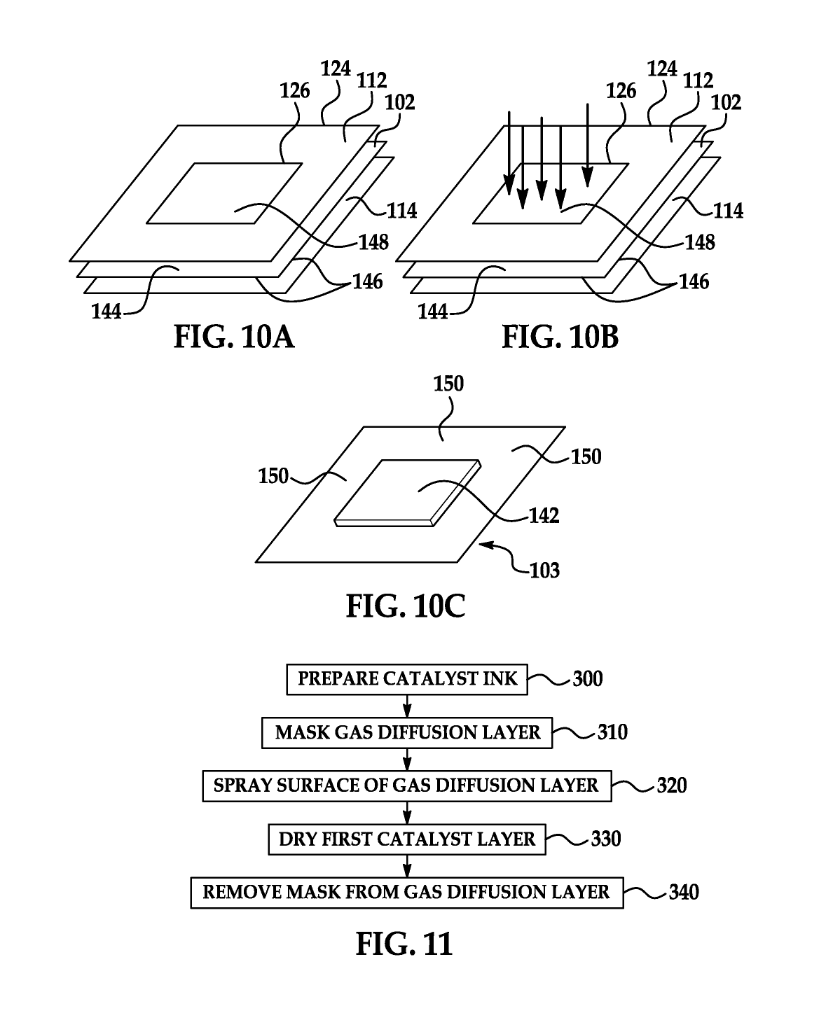

Embodiments of the magnetic mask 110 disclosed herein can be used to spray catalyst ink directly on to the gas diffusion layer 102 as the electrode substrate rather than the membrane 100 if desired or required to produce a gas diffusion electrode 103. FIGS. 10A-10C illustrate the use of the magnetic mask 110 to form a catalyst layer 142 on a gas diffusion layer 102. The first and second portions 112, 114 of the magnetic mask 110 are placed on the gas diffusion layer 102 as they are placed on the membrane 100. The exterior perimeter 124 of the magnetic mask 110 can be aligned with the perimeter 146 of the gas diffusion layer 102. Only one surface 144 of the gas diffusion layer 102 receives a catalyst layer 142. Accordingly, only one of the first and second portions 112, 114 of the magnetic mask 110 is required to have an interior perimeter 126 to form one treatment surface 148 on the gas diffusion layer 102.

The catalyst ink is sprayed onto the treatment surface 148 of the gas diffusion layer 102 in FIG. 10B. The catalyst ink and spray parameters are discussed above and will not be repeated here. The gas diffusion layer 102 and the magnetic mask 110 are dried in the oven. When the magnetic mask 110 is removed, the gas diffusion electrode 103 having the catalyst layer 142 is revealed surrounded by a border 150 of the gas diffusion layer 102.

Because the membrane 100 is relatively brittle and can wrinkle or tear if one tries to spray too much catalyst on the membrane 100, it is possible to spray part of the catalyst layer 104 onto the membrane 100 and the remainder of the catalyst layer 142 onto the gas diffusion layer 102. Both the membrane 100 and the gas diffusion layers 102 can be sprayed with catalyst ink if desired or required to achieve a desired thickness or differing catalyst areas that would not be feasible with spraying the membrane alone or the gas diffusion layer alone. The methods disclosed herein can be implemented, with the membrane 100 sandwiched between gas diffusion layers 102 such that the catalyst layer 104 of the membrane 100 contacts the catalyst layer 142 of the gas diffusion layer 102 and the catalyst layer 104′ of the membrane 100 contacts the catalyst layer 142′ of the other gas diffusion layer 102′.

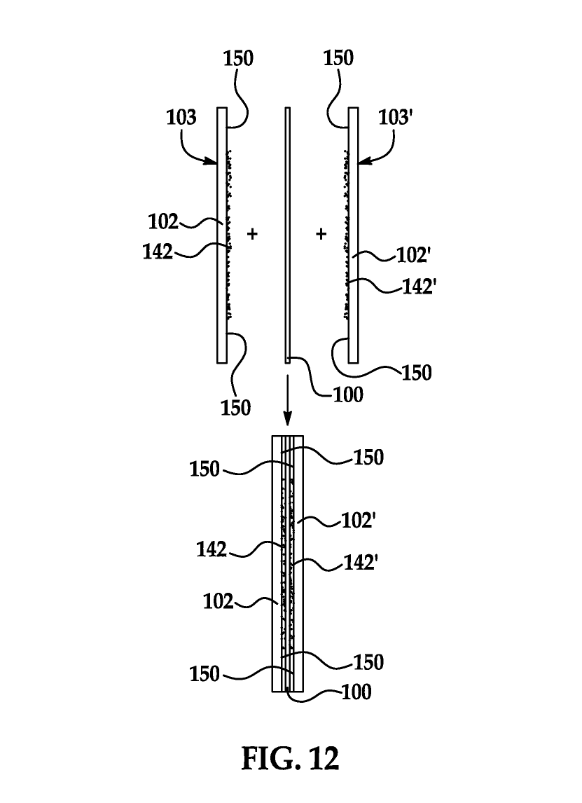

FIG. 11 is a flow diagram of another method of fabricating a membrane electrode assembly 20 for use in a fuel cell 70. The first step 300 is to prepare a catalyst ink of a predetermined viscosity as described with regard to the earlier embodiments. In the next step 310, a gas diffusion layer 102 having a first surface 144 is masked with the magnetic mask 110 to produce the treatment surface 148. In step 230, the catalyst ink is sprayed on the first surface 144 of the gas diffusion layer 102, forming the catalyst layer 142. The catalyst layer 142 is dried by heating the gas diffusion layer 102 and the magnetic mask 110 in the oven at a predetermined temperature for a predetermined period of time in step 330. In step 340, the magnetic mask 110 is removed from the gas diffusion layer 102 to reveal the gas diffusion electrode 103 having the catalyst layer 142 and the gas diffusion border 150. This method is repeated to produce a second gas diffusion electrode 103′ having a second gas diffusion layer 102′ with a second catalyst layer 142′. The membrane electrode assembly 120 is assembled as shown in FIG. 12 by sandwiching a membrane 100 between the two gas diffusion electrodes 103, 103′ so that the catalyst layers 142, 142′ contact the membrane 100.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A method of fabricating a membrane electrode assembly for a fuel cell comprising:
preparing a catalyst ink of a predetermined viscosity;
first masking an electrode substrate having a first surface and a second surface with a magnetic mask, wherein the magnetic mask comprises a first portion positioned on the first surface to produce a first treatment area, and a second portion positioned on the second surface to produce a second treatment area; and
after masking, forming an active electrode layer by:
spraying the catalyst ink on the first treatment area and drying the catalyst ink by heating the electrode substrate and the magnetic mask in an oven at a predetermined temperature for a predetermined period of time; and
spraying the catalyst ink on the second treatment area and drying the catalyst ink by heating the electrode substrate and the magnetic mask in the oven at the predetermined temperature for the predetermined period of time.

2. The method of claim 1, wherein the electrode substrate is a membrane.

3. The method of claim 2, wherein the first portion of the magnetic mask frames the first surface of the membrane and the second portion of the magnetic mask frames the second surface of the membrane such that an area of the first treatment portion is equal to an area of the second treatment portion.

4. The method of claim 2, wherein the membrane has a perimeter and each of the first portion and second portion of the magnetic mask has an exterior perimeter and an interior perimeter spaced from the exterior perimeter by a width, and masking the membrane further comprises aligning the perimeter of the membrane with the exterior perimeter of each of the first portion and second portion of the magnetic mask.

5. The method of claim 4, wherein the width of the magnetic mask corresponds to a dead space of the membrane.

6. The method of claim 1, wherein the electrode substrate is a gas diffusion layer.

7. The method of claim 1, wherein the magnetic mask has a non-reactive coating.

8. The method of claim 1, wherein the predetermined temperature is from about 75° C. to about 85°

9. The method of claim 1, wherein the predetermined period of time is about twenty to thirty minutes.

10. The method of claim 1, wherein the active electrode layer has a uniform catalyst loading between 0.05 and 0.20 mg Pt/cm².

11. The method of claim 2 further comprising:
removing the magnetic mask from the membrane; and
assembling the membrane between two gas diffusion layers.

12. A method of making a membrane electrode assembly for a fuel cell comprising:
preparing a catalyst ink of a predetermined viscosity;
masking an electrode substrate having a first surface with a first portion of a magnetic mask;
masking a second surface opposite the first surface of the electrode substrate with a second portion of the magnetic mask;
spraying the catalyst ink on the first surface of the electrode substrate;
drying the catalyst ink by heating the electrode substrate and the magnetic mask in an oven at a predetermined temperature for a predetermined period of time;
spraying the catalyst ink on the second surface of the electrode substrate; and
drying the catalyst ink by heating the electrode substrate and the magnetic mask in the oven at the predetermined temperature for the predetermined period of time.

13. The method of claim 12, wherein the electrode substrate is a membrane.

14. The method of claim 13, wherein the first portion of the magnetic mask is equal to and aligned with the second portion.

15. The method of claim 13, wherein each of the first portion and the second portion of the magnetic mask is configured to frame the first surface and second surface of the membrane respectively.

16. The method of claim 14, wherein the membrane has a perimeter and each of the first portion and second portion of the magnetic mask has an exterior perimeter and an interior perimeter spaced from the exterior perimeter by a width, and masking the membrane further comprises aligning the perimeter of the membrane with the exterior perimeter of each of the first portion and second portion of the magnetic mask.

17. The method of claim 16, wherein the width of the magnetic mask corresponds to a dead space of the membrane.

18. The method of claim 13 further comprising:
removing the magnetic mask from the membrane; and
assembling the membrane between two gas diffusion layers.

19. The method of claim 12, wherein the active electrode layer has a uniform catalyst loading between 0.05 and 0.20 mg Pt/cm².

20. (canceled)

21. (canceled)

22. (canceled)

23. (canceled)
